(19) United States
(12) Patent Application Publication
(10) Pub. No.: US 2001/0012780 A1
(43) Pub. Date: Aug. 9, 2001

(54) CELLULAR COMMUNICATIONS FREQUENCY PLAN SYSTEM

(76) Inventor: KEITH RUSSELL EDWARDS, DEVON (GB)

Correspondence Address: WILLIAM M. LEE, JR., LEE, MANN, SMITH, MCWILLIAMS, SWEENEY &, OHLSON, P.O. BOX 2786, CHICAGO, IL, 606902786

(21) Appl. No.: 09/141,447

(22) Filed: Aug. 27, 1998

(30) Foreign Application Priority Data
Dec. 24, 1997 (GB) 9727348.6
May 1, 1998 (GB) 9809310.7

(51) Int. Cl. H04Q 7/20

(52) U.S. Cl. 455/446; 455/447; 455/561

(57) ABSTRACT

The invention relates to a fixed wireless access telecommunications system wherein there is provided a multi tier, preferably two tier, frequency plan in which a number of frequency plans, preferably two frequency plans are overlaid. Thus, a first frequency plan can be implemented using first sets of antenna elements and additional overlaid frequency plans can be implemented using additional sets of antenna elements which may be co-located at the base stations with the first sets of antenna elements. The frequency plans may be sectored with the base station comprising at least one directional antenna. The first and second frequency plans are generally the have the same topology except that the first frequency plan is rotated relative to the second. According to one aspect of the system, first and second frequency plans are tri-sectored and the first frequency plan is rotated through an angle such that each sector boundary of the first frequency plan bisects a sector of the second frequency plan such that when the frequency plans are overlaid a hex-sectored frequency plan is generated.

### FIELD OF THE INVENTION

This invention relates to a wireless access cellular communications system and in particular relates to a cellular communications frequency plan for a fixed wireless access cellular communications system.

### FIELD OF THE INVENTION

Fixed wireless access systems are currently employed for local telecommunication networks, such as the IONICA system. Known systems comprise an antenna and decoding means which are located at a subscriber's premises, for instance adjacent a telephone. The antenna receives the signal and forwards it by wire to a decoding means. Thus subscribers are connected to a telecommunications network by radio link in place of the more traditional method of copper cable. Such fixed wireless access systems will be capable of delivering a wide range of access services from POTS (public operator telephone service), ISDN (integrated services digital network) to broadband data. The antennas at the subscribers premises communicate with a base station, which provides cellular coverage within a cell with a radius, typically of 15 km. A typical base station will support 500-2000 subscribers. Each base station is connected to a standard PSTN switch via a conventional transmission link/network.

In this document the term cell is used to define an area that is served by a single base station. The edges of a cell are defined by equal signal power boundaries with adjacent cells. For example referring to FIG. 1, the cells associated with each base station (B₁ to B₇—the position of each base station is represented by a black dot) are hexagonal. Referring to cell boundary (31) of FIG. 1, this is a straight cell boundary between the cells associated with base stations B₁ and B₂ and represents the line along which the signal strength from base station B₁ equals the signal strength from base station B₂. Accordingly, it can be seen that the arrangement of the array of base stations B₁ to B₇ results in cells which have hexagonal shapes, at least relying on a flat earth model. Of course when base stations are deployed on the ground, the ground will not be flat and obtaining base stations sites which are as regularly spaced as those in FIG. 1 is very difficult. Accordingly, the ideal flat earth model frequency plans in this document may become distorted when implemented and so may require minor modifications.

When a fixed wireless access telecommunications system is initially deployed, then a base station of a particular capacity will be installed to cover a particular populated area. The capabilities of the base station are designed to be commensurate with the anticipated coverage and capacity requirement.

Subscribers' antennas will be mounted outside, for instance, on a chimney, and upon installation will normally be directed towards the nearest (or best signal strength) base station or repeater antenna (any future reference to a base station shall be taken to include a repeater). In order to meet the capacity demand, within an available frequency band allocation, fixed wireless access systems divide a geographic area to be covered into cells. Within each cell is a base station through which the subscribers' systems communicate; the distance between the cells being determined such that co-channel interference is maintained at a tolerable level. When the antenna on the subscriber premises is installed, an optimal direction for the subscriber's antenna is identified using monitoring equipment. The antenna is then mounted so that it is positioned towards said optimal direction.

Fixed wireless access systems comprise a network of base stations, such as B₁ to B₇ of FIG. 1, each serving a cell of up to 15 km radius (typically). Each base station interfaces with the subscriber systems within its associated cell via a purpose designed air interface protocol. The base station also interfaces with the public telephone network for example, this interface can be the North American 24 timeslot standard known as T1.

Typically, each uplink radio channel (i.e. from a subscriber antenna to a base station) is paired with a downlink radio channel (i.e. from, a base station to a subscriber antenna) to produce a duplex radio channel. For voice signals the up and down link channels in a pair normally have the same frequency separation (e.g. 50 MHz between uplink and downlink channels) because this makes the process of channel allocation simple. However, it is possible for the up and down link channels in a pair to have different frequency separations. Often each downlink transmits continuously and it is usual for those downlink bearers used to carry broadcast information to transmit continuously. In the uplink each subscriber antenna typically only transmits a packet of information when necessary.

A bearer (or carrier) is a frequency channel, often with several logical channels, for example, ten channels. Base stations are then allocated radio bearers from the total available, for example, 54. As the subscriber population increases the base station capacity can be increased by increasing the number of bearers allocated to it, for example, 3, 6 or 18 bearers.

As already mentioned, fixed wireless access systems divide a geographic area to be covered into cells. For initial planning and design purposes these cells are generally represented as hexagons, each cell being served by a base station (generally in the centre of the hexagon) with which a plurality of subscriber stations within the cell communicate. When detailed cell planning is performed the ideal hexagonal arrangement can start to break down due to site constraints or for radio propagation reasons. The number of subscriber stations which can be supported within each cell is limited by the available number of carrier frequencies and the number of logic channels per frequency carrier or bearer.

Finding base station sites is expensive, and requires extensive effort in obtaining planning permission for their erection. In some areas, suitable base station sites may not be available. One problem in fixed wireless access system design is to have as few base stations as possible, whilst supporting as many subscriber stations as possible. This helps to reduce the cost per subscriber in a fixed wireless access system. An on-going problem is to increase the traffic carrying capacity of base stations whilst at the same time keeping interference levels within acceptable bounds. This is referred to as the optimisation or increase of the carrier to interference level ratio. By increasing the traffic capacity the number of lost or blocked calls is reduced and call quality can be improved. (A lost call is a call attempt that fails).

Cells are typically grouped in clusters as shown in FIG. 1. In this example, a cluster of seven cells is shown and for a 6 bearer system, each cell in the cluster may use a different group of 6 frequencies out of the total available (or example, 54). Within each cluster 7×6=42 frequencies are each used once. This leaves 12 channels for in-fill if required. Within the cluster all channels are orthogonal, that is, separated by emitter time and/or frequency, and therefore there will be no co-channel interference within this isolated cluster.

FIG. 2 shows how a larger geographical area can be covered by re-using frequencies. In FIG. 2 each frequency is used twice, once in each cluster. Co-channel interference could occur between cells using the same frequencies, for example cells associated with base stations (16) and (18), and needs to be guarded against by careful allocation of bearers to each cell, ie. through cell planning.

When the capacity of a cell or cluster is exhausted one possibility is to split each cell into directional sectors, as shown in FIG. 3. This involves using directional antennas on the base station rather than omnidirectional antennas. The 360° range around the base station is divided up into a number of sectors and bearers are allocated to each sector. In FIG. 3, the hexagonal cell associated with each base station (B) is tri-sectored, ie. it is split into three sectors. For example, the hexagonal cell associated with base station (35) is split into three sectors labelled A1, A2 and A3. A first directional antenna at the base station (35) will cover sector A1, a second directional antenna at base station will cover sector A2 and a third direction antenna at the base station (35) will cover sector A3.

In this way more bearers can be added whilst keeping interference down by only using certain frequencies in certain directions or sectors. As discussed in relation to FIG. 1, each cell was allocated 6 bearers. By sectorising the cells in accordance with FIG. 3, each sector can be allocated, for example, 6 bearers. Thus, for example, 12 bearers per cell could be added giving a total of 18 bearers per cell. The number of cells required to use all 54 bearers then reduces to three, and so there are three cells in each cluster, as shown in FIG. 3. This is because all 54 frequencies are used in the cluster and will be re-used in other clusters.

Known approaches for seeking to increase system capacity include frequency planning which involves carefully planning re-use patterns and creating sector designs in order to reduce the likelihood of interference. However, this method is complex and difficult and there is still the possibility that unwanted multipath reflections may cause excessive interference. Frequency planning is also expensive and time consuming and slows down the rate of deployment. Some of the difficulties with frequency planning include that it relies on having a good terrain base and a good prediction tool.

As well as fixed wireless access cellular communications system, the present invention could also be applied to other wireless access cellular communications systems, such as slowly varying mobile access systems, where similar considerations exist.

WO96/13952 describes a method for hexagonal sectored obtaining a one cell re-use pattern in a wireless communications system but does not provide a suitable operational system.

### OBJECT OF THE INVENTION

The present invention seeks to provide an improved arrangement for upgrading frequency plans in a wireless access cellular communications system which overcomes or at least mitigates one or more of the problems noted above. It is sought to upgrade the traffic carrying capacity of base stations whilst at the same time keeping interference levels to a minimum.

### SUMMARY OF THE INVENTION

In accordance with a first aspect of the invention, there is provided a wireless access cellular communications system wherein there is provided a multi tier frequency plan wherein a number of frequency plans are overlaid. This can enable an increase in the traffic carrying capacity of a base station whilst, with careful arrangement, interference levels can be kept to acceptable levels. A two tier frequency plan is preferred wherein a first frequency plan is overlaid with a second frequency plan.

The present invention allows a base station to be deployed with a first set of antenna elements (or groups) which implement a first frequency plan. When the first frequency plan becomes overloaded due to an increase in the use of the network over time, the base station may be upgraded by implementing a second frequency plan, to overlay the first, using an additional set of antenna elements (or groups). Optionally, the initially deployed first frequency plan can be changed so that it compliments the overlaid second frequency plan. In this way each overlaid frequency plan may be generated by separate sets of antenna elements and the antenna elements associated with overlaid cells of different overlaid frequency plans may be co-located.

Preferably, the system is a fixed wireless access cellular communications system, although the present invention could also be applied to other wireless access cellular communications systems, such as slowly varying mobile access systems.

In a preferred arrangement at least one of the frequency plans is sectored. The first and second frequency plans preferably have the same cell topography except that the first frequency plan is rotated through an angle, preferably 180°, relative to the second. Overlaid cells of the frequency plans are implemented using the same base station and so capacity can be increased according to the present invention without increasing the number of base stations required.

The first frequency plan is preferably rotated through an angle such that each sector boundary of the first frequency plan passes through, and preferably bisects, a sector of the second frequency plan.

At least some of the carriers (ie. bearers) used in a cell in a first frequency plan may be reused in a corresponding overlaid cell of a second frequency plan. This increases the capacity of the base station. When at least some of the carriers used in a cell in a first frequency plan are reused in a corresponding overlaid cell of a second frequency plan it is preferred, in order to provide spatial diversity, that the carriers in the first frequency plan that are reused in a corresponding overlaid cell of the second frequency plan are oppositely directed to the same carriers in the first frequency plan. In the extreme, with careful cell planning, all the carriers used in a cell of a first frequency plan may be reused in a corresponding overlaid cell of a second overlaid frequency plan.

To reduce interference levels carriers in the first frequency plan can be oppositely polarised to carriers in the second frequency plan.

Subscribers can be switched between the two overlaid frequency plans, for example, if one of the frequency plans becomes heavily used. Such switching can be used to maintain equal usage of both frequency plans and thus reduce interference levels.

Preferably, the first and second frequency plans are both tri-sectored with the sectors preferably arranged such that one of the frequency plans is rotated 180° with respect to the other—of course, this may also be expressed as ±60° rotation. In cases where there is low demand in a particular area one or more of the sectors may be dispensed with.

Preferably, the first and second frequency plans are tri-sectored, ie. each cell comprises three sectors. Each sector may be hexagonal. The base station antenna for each sector may have a 60° main beamwidth. In this case the first frequency plan can be rotated through 180° to the second frequency plan and superimposed over the first frequency plan to generate a hex-sectored composite frequency plan.

Where the system becomes overloaded only in certain areas it is possible to implement the multi-tier frequency plan according to the present invention over a part of the wireless access cellular communications system, ie. in the overloaded areas only.

According to a second aspect of the present invention there is provided a method of deploying a wireless access cellular communications system wherein a first frequency plan is overlaid with at least one other frequency plan. The first frequency plan may be implemented using first sets of antenna elements and the second frequency plan may be implemented using second sets of antenna elements. Preferably, a first set and a second set of antenna elements implementing the frequency plans in overlaid cells are co-located.

### BRIEF DESCRIPTION OF THE DRAWINGS

In order that the present invention is more fully understood and to show how the same may be carried into effect, reference shall now be made, by way of example only, to the figures as shown in the accompanying drawing sheets, wherein:

FIG. 1 shows a cluster of seven cells that are represented as hexagons;

FIG. 2 shows two clusters of seven cells where each frequency is re-sued twice, once in each cluster;

FIG. 3 shows three clusters of three tri-sectored cells;

FIG. 4 shows a first tri-sectored frequency plan, in which each sector is hexagonal;

FIGS. 5 shows a second tri-sectored frequency plan, in which each sector is hexagonal and which has the same cell topology as the frequency plans of FIGS. 4 and 9, except that it is rotated through 180° with respect to the frequency plans of FIGS. 4 and 9;

FIG. 6a shows a cell from the frequency plan of FIG. 4, FIG. 6b shows a cell from the frequency plan of FIG. 5 and FIG. 6c shows the hex sectored cell generated when the cells of FIG. 6a and 6b are overlaid;

FIG. 7 shows a hex-sectored frequency plan according to the present invention generated when the two frequency plans of FIGS. 4 and 5 are overlaid;

FIG. 8 shows the hex-sectored frequency plan of FIG. 7 with polarisation diversity added;

FIG. 9 shows a tri-sectored frequency plan, in which each sector is hexagonal;

FIG. 10a shows a cell of the frequency plan of FIG. 9 to which additional bearers have been added in accordance with the frequency plan of FIG. 4, FIG. 10b shows a cell of the frequency plan of FIG. 5 and FIG. 10c shows the cell which is generated when the cells of FIGS. 10a and 10b are overlaid, ie. a tri-sectored cell overlaid with a hex-sectored cell;

FIG. 11 shows the frequency plan according to the present invention generated by overlaying the frequency plan of FIG. 9 with the hex-sectored frequency plan shown in FIG. 8;

FIG. 12 shows a first antenna arrangement suitable for putting the frequency plans of the present invention into effect; and

FIG. 13 shows a second antenna arrangement suitable for putting the frequency plans of the present invention into effect.

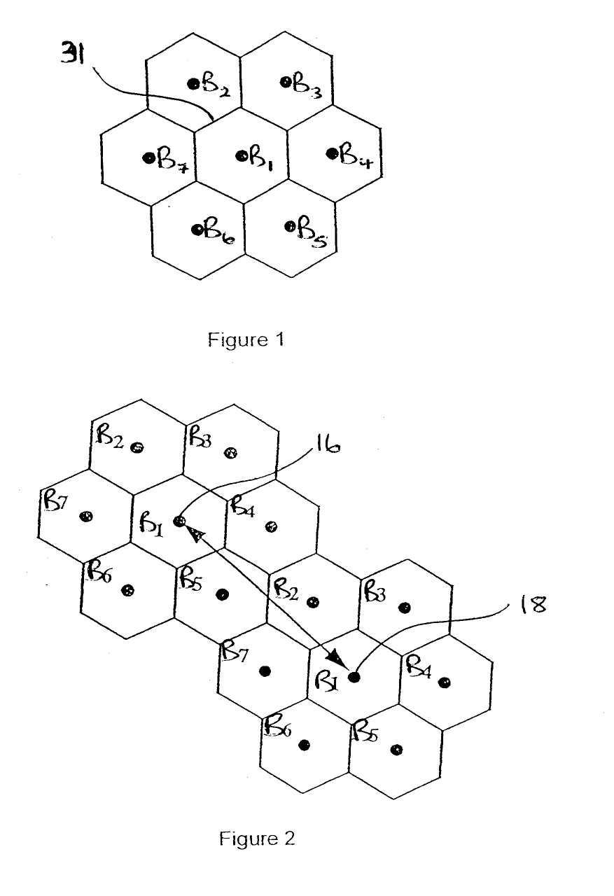

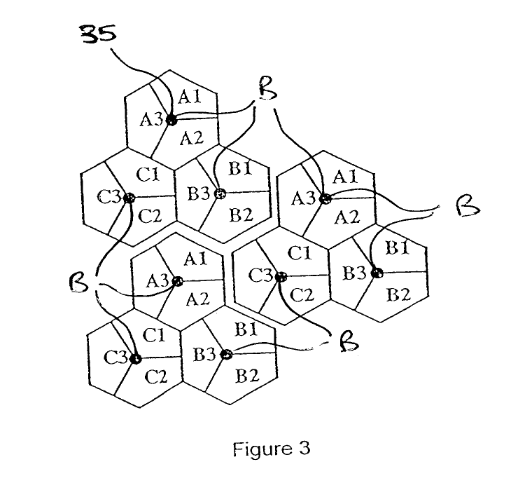

### DETAILED DESCRIPTION OF PREFERRED EMBODIMENTS

There will now be described by way of example the best mode contemplated by the inventor for carrying out the invention. In the following description, numerous specific details are set out in order to provide a complete understanding of the present invention. It will be apparent, however, to those skilled in the art that the present invention may be put into practice with variations of the specific.

As set out above, in this document the term cell is used to define an area that is served by a single base station. The edges of a cell are defined by equal signal power boundaries with adjacent cells. Cells can be split into directional sectors. For example, a cell can tri-sectored, ie. split into three direction sectors, or hex-sectored, ie. split into six directional sectors.

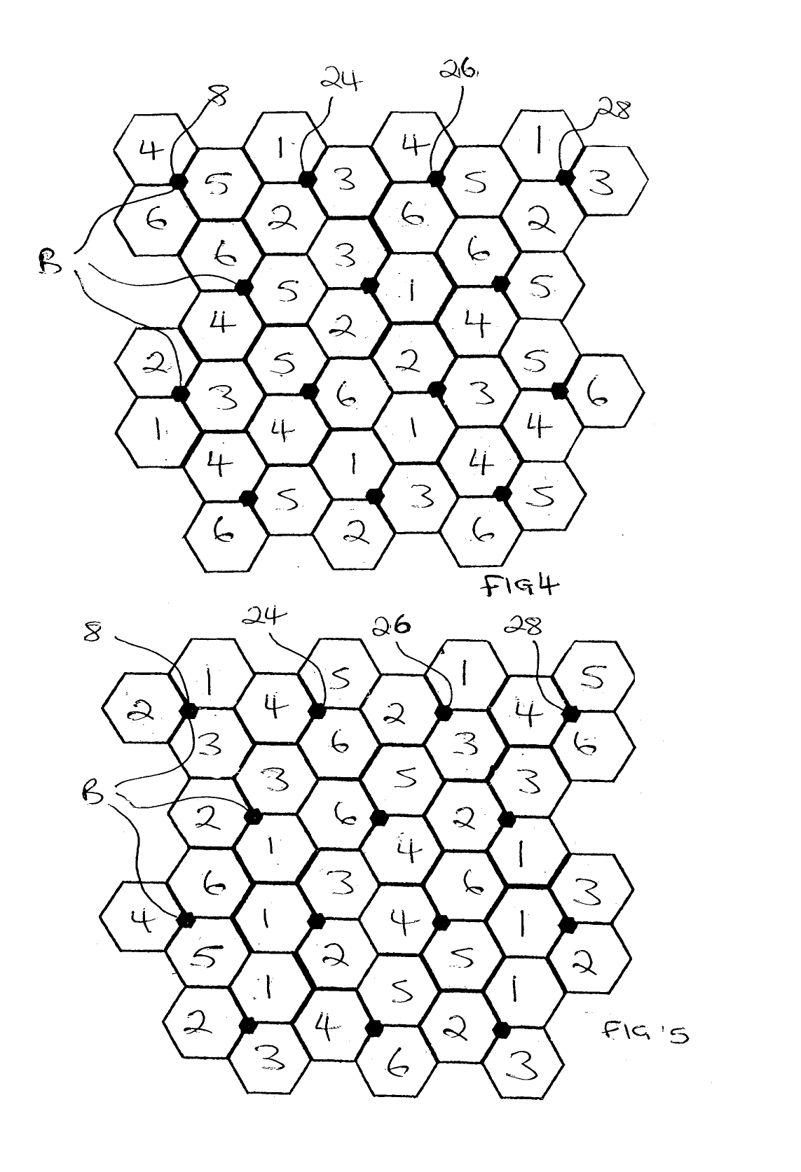

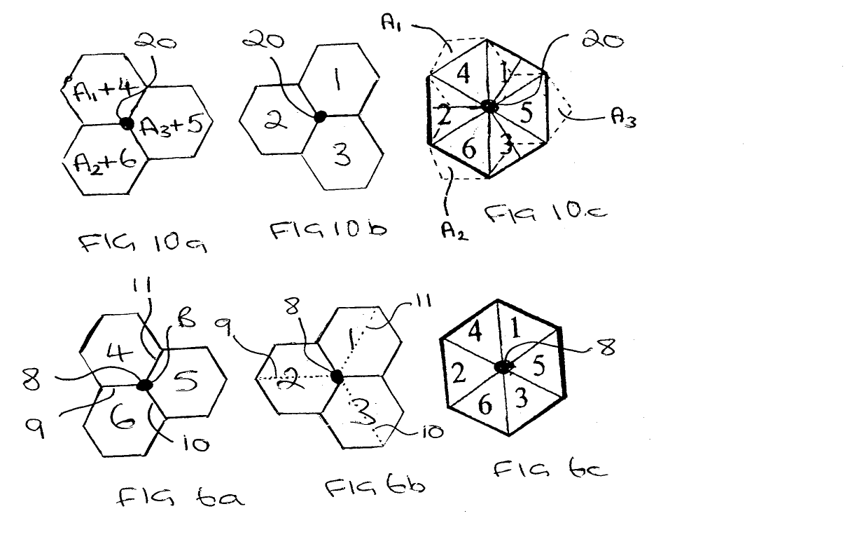

Referring now to FIG. 4 there is shown part of a first tri-sectored frequency plan using base stations (B) having directional antennas. The top left hand cell of the frequency plan of FIG. 4 is shown in FIG. 6a. Each base station (B) supports three hexagonal sectors, for example, base station (8) supports three hexagonal sectors which are each allocated a number of bearers. For example if 9 bearers are allocated to each sector then there will be a total of 27 bearers per cell. FIG. 5 shows part of a second frequency plan with an identical cell topology to the first except that each cell is rotated through 180° relative to the frequency plan shown in FIG. 4. The frequency plan structure of FIG. 5 can be achieved by rotating the frequency plan of FIG. 4 through 180° or equivalently by rotating each cell of the frequency plan of FIG. 4 through 180°. It can be seen that this 180° rotation of the frequency plan is effectively equivalent to a + or −60° rotation. The top left hand cell of the frequency plan of FIG. 5 is shown in FIG. 6b.

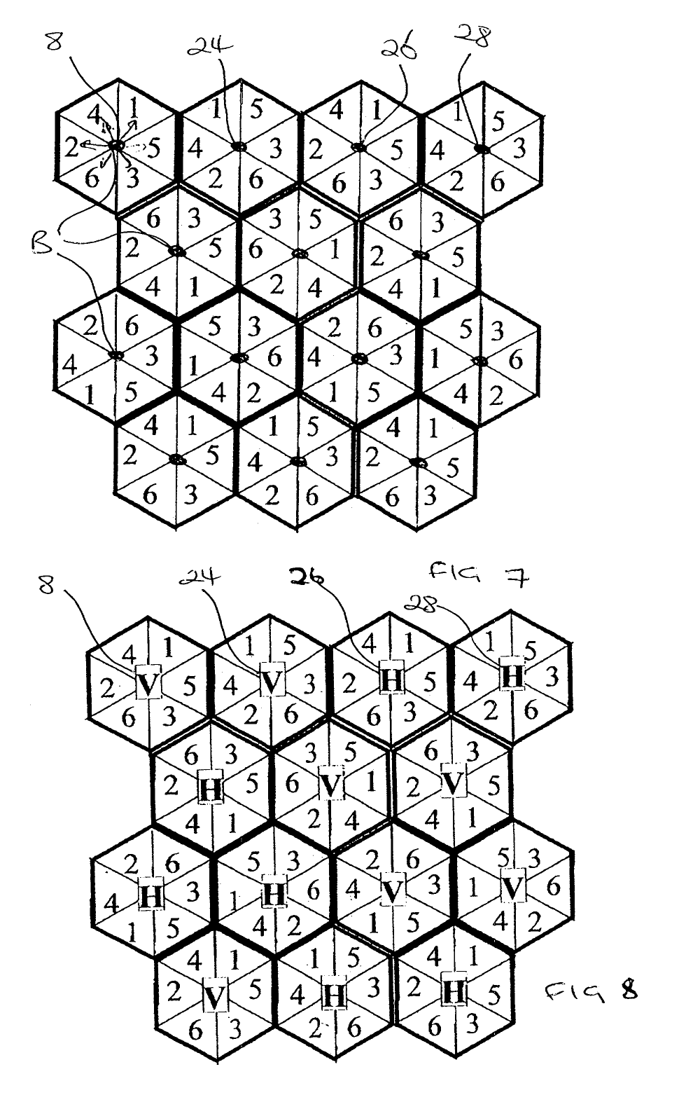

FIG. 6c shows the hex-sectored cell which is generated when the cells of FIGS. 6a and 6b are overlaid. When the cells of FIG. 6a and 6b are overlaid the sector boundaries (9,10,11) in the cell of FIG. 6a bisect the sectors of FIG. 6b (as shown in FIG. 6b in dotted lines (9,10,11)) and vice versa. It can be seen that redrawing the equal signal strength boundaries between sectors when two tri-sectored cells are overlaid in this way results in the single hex-sectored cell of FIG. 6c (the top left hand cell of FIG. 7). Also, as the triangular sectors of the cell in FIG. 6c are smaller in area than the hexagonal sectors of the cells in FIGS. 6a and 6b the signal strength received by subscribers within the triangular sectors of FIG. 6c will be better than those received by subscribers within parts of the hexagonal sectors of FIGS. 6a and 6b most distant from the base station.

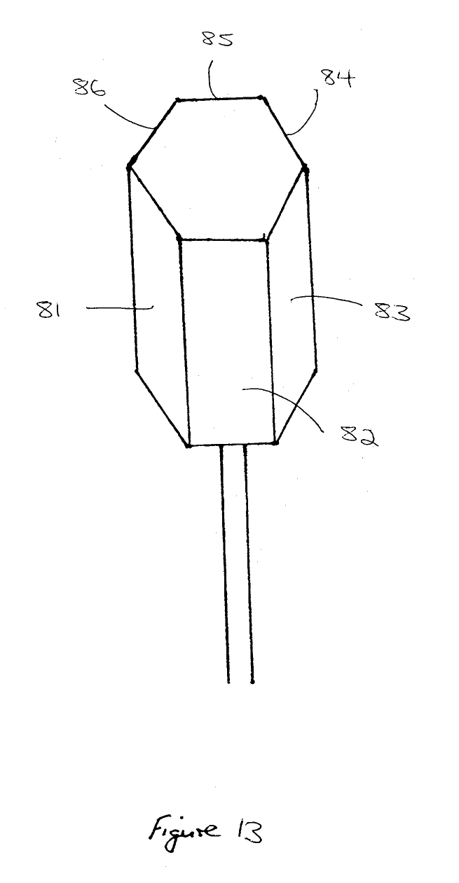

When a fixed wireless access telecommunications network is initially deployed it may be deployed according to the frequency plan of FIG. 4. When all or parts of the network become overloaded due to increased usage, the frequency plan of FIG. 5 can be deployed in addition to that of FIG. 4, using additional antennas located at the same base stations (See FIGS. 12 and 13 which are discussed below), over the whole or particularly overloaded parts of the network. The overlaying of the frequency plans of FIGS. 4 and 5 generates the higher capacity frequency plan of FIG. 7.

The frequency plan of FIGS. 4 and 5 use 54 bearers. For example, bearer set (1) comprises bearers 1, 7, 13, 19, 25, 31, 37, 43 and 49, bearer set (2) comprises bearers 2, 8, 14, 26, 32, 38, 44 and 50, bearer set (3) comprises bearers 3, 9, 15, 21, 27, 33, 39, 45 and 51, bearer set (4) comprising bearers 4, 10, 16, 22, 28, 34, 40, 46 and 52, bearer set (5) comprises bearers 5, 11, 17, 23, 29, 35, 41, 47 and 53 and bearer set (6) comprises bearers 6, 12, 18, 24, 30, 36, 42, 48 and 54. These bearer sets are allocated in accordance with the sector numbering of the frequency plans shown in FIGS. 4 and 5. Accordingly, the cell in FIG. 6a associated with base station (8) is allocated half of the total number of bearers. Each cell in the plans of FIGS. 4 and 5 are therefore allocated half of the total number of bearers and alternate cells in a row of cells, for example cells associated with base stations (8) and (26) in the top row of FIG. 4 are allocated bearer sets (4), (5) and (6), with the remaining cells in the top row, for example cells associated with base stations (24) and (28), being allocated bearer sets (1), (2) and (3).

The three sectors of the cell shown in FIG. 6a (the top left hand cell of FIG. 4) are allocated bearer sets 4, 5 and 6 and the three sectors of the cell shown in FIG. 6b (the top left hand cell of FIG. 5) are allocated bearer sets 1, 2 and 3. Then it can be seen that in the overlaid plan of FIG. 6c sectors with bearer set 1 are overlaid by two sectors one with bearer set 4 and the other with bearer set 5. Similarly, sectors with bearer set 2 are overlaid by two sectors one with bearer set 4 and the other with bearer set 6 and so on.

The composite hex-sectored frequency plan of FIG. 7 generated by overlaying the frequency plans of FIGS. 4 and 5 has triangular sectors. Sectors marked 1, operate with bearer sets (1) etc. Thus each hex-sectored cell in the frequency plan uses all the bearers. This doubles the frequency re-use of the composite frequency plan of FIG. 7 as compared to the original frequency plan of FIG. 4 in which each cell uses only one half of all bearers.

Accordingly, it can be seen that the overlaying of frequency plans according to the present invention can provide an efficient way of upgrading coverage to increase the cell capacity, without having to provide additional base station sites.

Referring now to FIG. 8, as would be more appropriate in a typical environment, a different radiation polarisation could be used for difference cells of the frequency plan of FIG. 7, thus giving polarisation diversity. In the frequency plan of FIG. 8, those cells marked with an H would operate using horizontally polarised microwave radiation and those cells marked with a V would operate using vertically polarised microwave radiation. It can be seen that in each row of cells from left to right there alternating pairs of horizontally polarised and vertically polarised cells, ie. two cells (eg. (8) and (24)) which have a first polarisation (in this case vertical) followed by two cells (eg. (26) and (28) which have a second opposite polarisation (in this case horizontal).

To further enhance the received C/I ratio in a polarisation diversity arrangement, the base and/or subscriber terminal can be equipped with a cross-polar interference cancel arrangement.

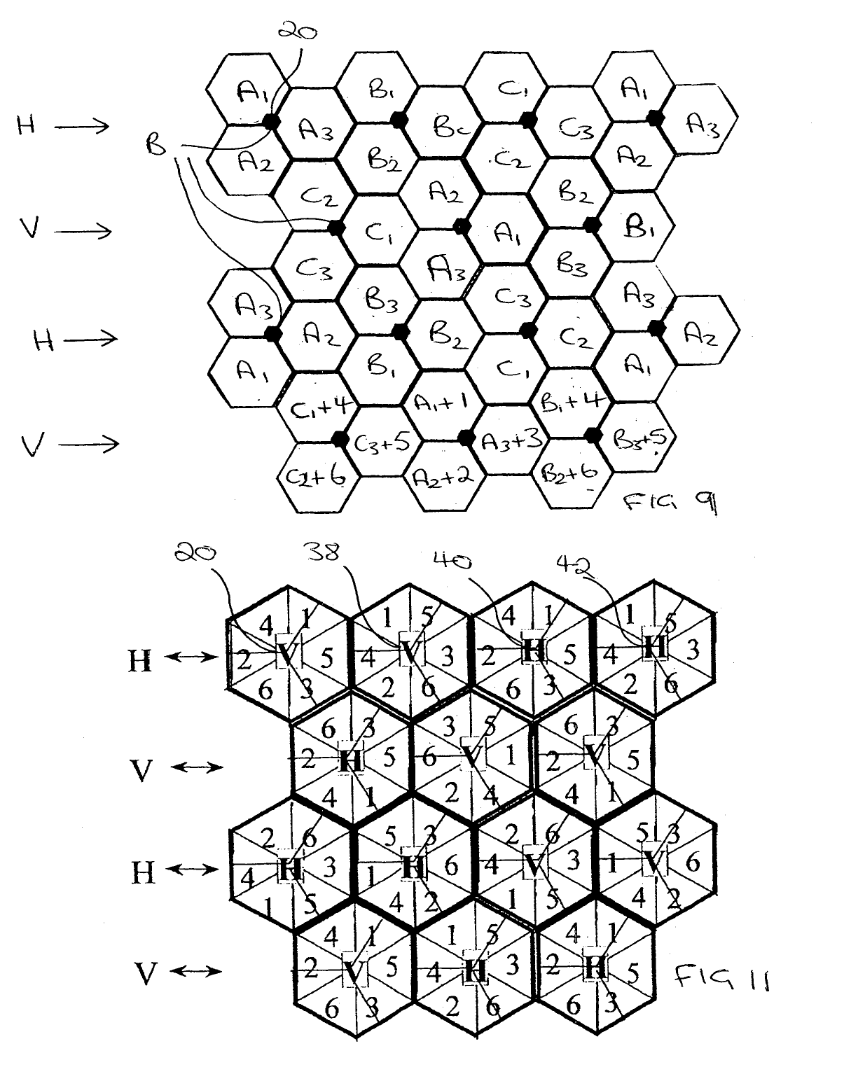

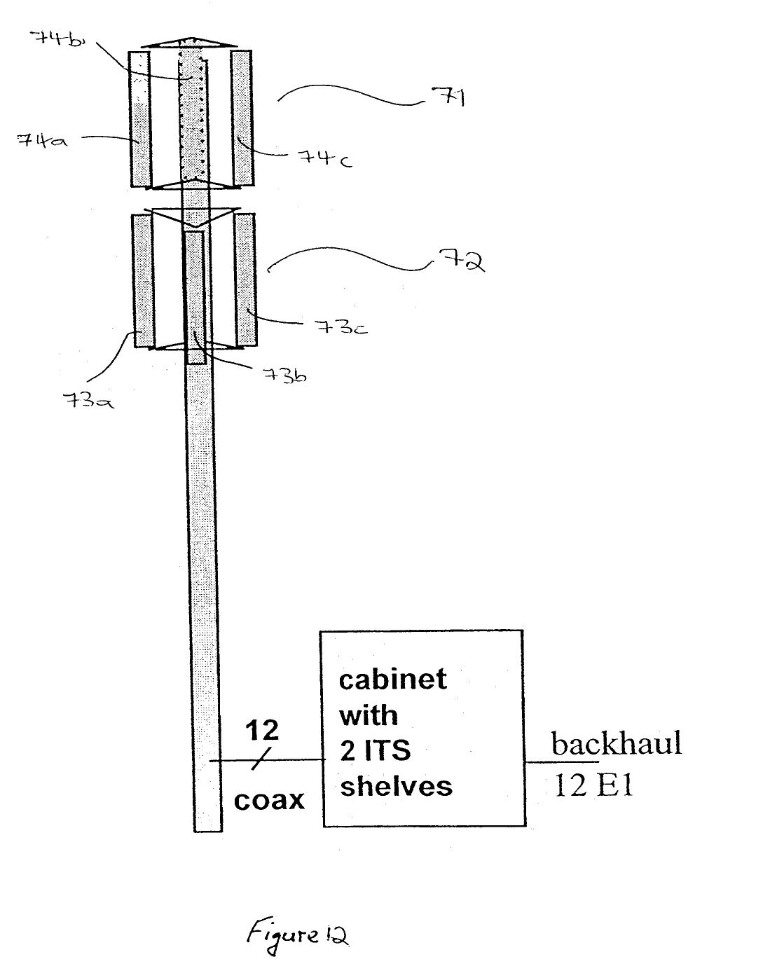

Referring now to FIG. 9 in which is shown a part of a tri-sectored frequency plan using directional antennas in which each 120° hexagonally shaped sector, eg. A1, is allocated a number of bearers. Each hexagonal sector is fed by a directional antenna at an associated base station (B). Each directional antenna has a main beamwidth of 60°, ie. the half power points of the antenna pattern are located at 30° to either side of the antenna bore site and the gain is typically reduced by a further 10 to 13 dB at 60° to either side of the antenna bore site. The top left hand cell of the frequency plan of FIG. 9 is shown in FIG. 10a with extra bearer sets added as will be described below.

When implemented the frequency plan shown in FIG. 9 may, for example, have nine different bearer sets A1, A2, A3, B1, B2, B3, C1, C2 and C3. For example, out of 54 bearers, frequency group A1 would be allocated with bearers 1, 10, 19, 28, 37 and 46, B1 would be allocated with channels 2, 11, 20, 29, 38, and 47, C1 would be allocated with bearers 3, 12, 21, 30, 39 and 48 and A2 would be allocated with bearers 4, 13, 22, 31, 40 and 49 and so on, where adjacent numbered bearers have adjacent channel frequencies. Accordingly, a third of all bearers are used in each cell, eg. a third of the bearers are used in the cell associated with base station (20) comprising hexagonal sectors A1, A2 and A3. In order to improve co-channel interference in this implementation of the tri-sectored frequency plan of FIG. 9, it is preferred that the base stations (B) along the horizontal rows of base stations marked with an H, have antennas that transceive predominantly horizontally polarised radiation and that the base stations (B) along the horizontal rows marked with a V have antennas that transceive predominantly vertically polarised radiation.

If it is necessary to upgrade the frequency plan of FIG. 9 because demand has outstripped the capacity of the frequency plan this can be achieved by overlaying the original tri-sectored frequency plan of FIG. 9 with the hex sectored frequency plan shown in FIG. 8. This is achieved by adding further bearer sets to the frequency plan of FIG. 9 in accordance with the frequency plan of FIG. 4 and overlaying the resulting frequency plan with the frequency plan of FIG. 5. It should be noted that this is possible because the frequency plans of FIGS. 4 and 9 have identical cell structures. Thus, the sectors of the top left hand cell of FIG. 9, already allocated bearer sets A1, A2 and A3 have added to them the bearer sets 4, 6 and 5 respectively, associated with the top left hand cell of the frequency plan of FIG. 4, as is shown in FIG. 10a. This is done for all cells of the frequency plan of FIG. 9, as is shown for the bottom row of cells of the frequency plan of FIG. 9 and can be implemented by using additional antennas at the base station sites.

Then the frequency plan of FIG. 9, with bearers added in accordance with the frequency plan of FIG. 4 (as shown in FIG. 10a and the bottom row of the frequency plan of FIG. 9) is overlaid by the frequency plan of FIG. 5. As described above the cell topology of the frequency plan of FIG. 5 is the same as that of the frequency plans of FIGS. 4 and 9 except that it is rotated through 180° (or + or −60°). When the frequency plan of FIG. 5 is overlaid, the frequency plan of FIG. 11 is generated. The frequency plan of FIG. 5 can be implemented using additional antennas located at the base station sites. As can be seen from FIG. 10c, when the cell of FIG. 10a (top left hand cell of FIG. 9 with bearers of top left hand cell of FIG. 4 added) is overlaid with the cell of FIG. 10b (top left hand cell of FIG. 5) the resultant cell comprises a hex-sectored cell structure as shown in FIG. 6c overlaid with a tri-sectored cell structure as shown the the top left hand cell of FIG. 9. When the cells of FIGS. 10a and 10b are overlaid, the equal signal strength sector boundaries move as described above in relation to the overlaying of FIGS. 6a and 6b to generate the hex-sectored cell structure of FIG. 6c. This leaves the tri-sectored frequency plan of FIG. 9 overlaid with the hex-sectored frequency plan of FIG. 7.

The polarisation of the overlaid hex-sectored cells is chosen in accordance with FIG. 8 and the polarisation of the tri-sectored cells is chosen in accordance with FIG. 9. Thus, in the frequency plan of FIG. 11 the antennas supporting of a first tri-sectored frequency plan are horizontally polarised in the horizontal rows of base stations marked with an H and are vertically polarised in the horizontal rows of base stations marked with a V. Also, in the frequency plan of FIG. 11, the antennas supporting the second overlaid hex-sectored frequency plan associated with a base station such as base stations (20) and (38) which are marked with a V are vertically polarised and the antennas supporting the hex-sectored frequency plan associated with a base station such as base stations (40) and (42) which are marked with a H are horizontally polarised. It can be seen that in each row of cells of the overlaid hex-sector plan from left to right there are alternating pairs of horizontally polarised and vertically polarised cells, ie. two cells (eg. (20) and (38)) which have a first polarisation (in this case vertical) followed by two cells (eg. (40) and (42) which have a second opposite polarisation (in this case horizontal). This means that some base stations will have antennas generating the tri-sectored cell which are horizontally polarised and antennas generating the overlaid hex-sectored cell which are vertically polarised (eg. base stations (20) and (38) of FIG. 11) and vice versa.

It should be noted that in the frequency plan of FIG. 11 each of the hexagonal sectors of the tri-sectored frequency plan (eg. A1, A2 and A3 of FIG. 10c) overlay parts of three triangular sectors of the hex-sectored frequency plan as shown in FIG. 10c. This permits better sharing of signals, to and from subscribers, between the two overlaid frequency plans.

FIGS. 12 and 13 provide two base station antenna arrangements capable of providing an overlaid frequency plan. In the first embodiment shown in FIG. 12, the arrangement comprises two tiers of antennas (71 and 72), each tier comprising a tri-sector antenna arrangement comprising three antenna groups (73a), (73b) and (73c) in tier (72) and (74a), (74b) and (74c) in tier (71) (the term antenna group is used here to cover also a single antenna). Each antenna group is arranged at 120° with respect to the other antenna groups and each antenna group covering 120° sector. This second tier is arranged at a 60° rotational offset with respect to the first tier. Initially, only one of the tiers of antennas would be deployed according a first, lower capacity frequency plan (eg. that of FIG. 4 or FIG. 9). Then when increased coverage is required the second tier would additionally be deployed in a second frequency plan (eg. that of FIG. 5) to overlay the first frequency plan to implement a higher capacity composite frequency plan.

In the antenna array arrangement shown in FIG. 13, there is shown a base station antenna arrangement having a hexagonal configuration with six antenna groups (81 to 86) directed outwardly from each of the six sides of the hexagon. Similarly, initially only alternate antennas (eg. 81, 83, 85) in the array would be deployed to implement a first frequency plan, for example, that of FIG. 4. Subsequently, the remaining antennas (eg. 82, 84, 86) would be deployed to implement a second frequency plan which would overlay the first frequency plan, for example that of FIG. 5.

In conditions when a first antenna group (eg. 81) supporting a first layer of a multi-layer frequency plan according to the present invention is operating at maximum capacity, then it will be realised that a subscriber could be switched to a second antenna group (eg. 82 or 86) supporting an underutilised second frequency plan. Handover could be possible to ensure that the usage of the base station is evenly distributed about the antenna.

1. A wireless access cellular communications system wherein there is provided a multi-tier frequency plan wherein a number of frequency plans are overlaid.

2. A system according to claim 1 wherein there is provided a two tier frequency plan wherein a first frequency plan is overlaid with a second frequency plan.

3. A system according to claim 1 wherein at least one of the frequency plans is sectored.

4. A system according to claim 1 wherein at least two of the frequency plans are sectored and a first sectored frequency plan is rotated through an angle relative to a second sectored frequency plan such that each sector boundary of the first frequency plan passes through a sector of the second frequency plan.

5. A system according to claim 1 wherein at least two of the frequency plans are sectored and a first sectored frequency plan is rotated through an angle such that each sector boundary of the first frequency plan bisects a sector of a second frequency plan.

6. A system according to claim 1 wherein at least some of the carriers used in a cell in a first frequency plan are reused in a corresponding overlaid cell of a second frequency plan.

7. A system according to claim 1 wherein at least some of the carriers used in a cell in a first frequency plan are reused in a corresponding overlaid cell of a second frequency plan and the carriers in the first frequency plan that are reused in a corresponding overlaid cell of the second frequency plan are oppositely directed to the same carriers in the second frequency plan.

8. A system according to claim 1 wherein subscribers can be switched between the overlaid frequency plans.

9. A system according to claim 1 wherein a first frequency plan and a second overlaid frequency plan are tri-sectored.

10. A system according to claim 1 wherein a first frequency plan and a second overlaid frequency plan are tri-sectored and the first frequency plan is rotated through an angle of 180° relative to the second.

11. A system according to claim 1 wherein a first frequency plan and a second overlaid frequency plan are tri-sectored and the first frequency plan is rotated through an angle such that each sector boundary of the first frequency plan passes through a sector of the second frequency plan.

12. A system according to claim 1 wherein a first frequency plan and a second overlaid frequency plan are tri-sectored and the first frequency plan is rotated through an angle such that each sector boundary of the first frequency plan bisects a sector of the second frequency plan.

13. A system according to claim 1 wherein the carriers in a first frequency plan are oppositely polarised to the carriers in a second overlaid frequency plan.

14. A system according to claim 1 wherein a first frequency plan and a second overlaid frequency plan are tri-sectored and are overlaid so as to generate a hex-sectored frequency plan.

15. A system according to claim 1 wherein a first frequency plan and a second overlaid frequency plan are tri-sectored and the first frequency plan is rotated through an angle of 180° relative to the second and are overlaid so as to generate a hex-sectored frequency plan.

16. A system according to claim 1 wherein a first frequency plan and a second overlaid frequency plan are tri-sectored and the first frequency plan is rotated through an angle such that each sector boundary of the first frequency plan passes through a sector of the second frequency plan such that when the frequency plans are overlaid a hex-sectored frequency plan is generated.

17. A system according to claim 1 wherein a first frequency plan and a second overlaid frequency plan are tri-sectored and the first frequency plan is rotated through an angle such that each sector boundary of the first frequency plan bisects a sector of the second frequency plan such that when the frequency plans are overlaid a hex-sectored frequency plan is generated.

18. A system according to claim 1 wherein at least two of the overlaid frequency plans have the same cell topology.

19. A system according to claim 1 wherein a multi-tier frequency plan is implemented over a part of a wireless access cellular communications system.

20. A system according to claim 1 wherein the system is a fixed wireless access cellular communications system.

21. A system according to claim 1 wherein a first frequency plan is implemented using first sets of antenna elements and an overlaid second frequency plan is implemented using additional sets of antenna elements.

22. A system according to claim 1 wherein a first frequency plan is implemented using first sets of antenna elements and an overlaid second frequency plan is implemented using additional sets of antenna elements and a first set of antenna elements and an additional set of antenna elements associated with overlaid cells of the first and second frequency plans are co-located.

23. A system according to claim 1 wherein one of the overlaid frequency plans comprises rows of cells and in each row there are alternating pairs of horizontally and vertically polarised cells.

24. A method of deploying a wireless access cellular communications system wherein a first frequency plan is overlaid with at least one other frequency plan.

25. A method according to claim 23 wherein the first frequency plan is implemented by deploying first sets of antenna elements and the second frequency plan is implemented by deploying additional sets of antenna elements.
